(19) United States
(12) Patent Application Publication
(10) Pub. No.: US 2024/0166850 A1
(43) Pub. Date: May 23, 2024

(54) RAPID-CURING TWO-COMPONENT COMPOSITION OF SILYLATED POLYMERS HAVING A LONG OPEN TIME

(71) Applicant: SIKA TECHNOLOGY AG, Baar (CH)

(72) Inventors: Klaas MENNECKE, Lottstetten (DE); Riccardo SUTER, Baden (CH)

(73) Assignee: SIKA TECHNOLOGY AG, Baar (CH)

(21) Appl. No.: 18/281,328

(22) PCT Filed: Apr. 12, 2022
(86) PCT No.: PCT/EP2022/059757

§ 371 Date: Sep. 11, 2023

(30) Foreign Application Priority Data
Apr. 21, 2021 (EP) 21169725.5

(51) Int. Cl. C08K 5/5419; C08G 18/10; C08K 5/5425; C08K 5/58; C08L 101/10; C09D 201/10; C09J 175/08

(52) U.S. Cl. CPC C08K 5/5419; C08G 18/10; C08K 5/5425; C08K 5/58; C08L 101/10; C09D 201/10; C09J 175/08; C09J 2475/00

(57) ABSTRACT

A component A, including at least one organic silane-group-containing polymer, at least one drying agent, at least one amine having at least one free amino group or latent amino group releasable via hydrolysis, at least one hydrolysable silane without an amino group, and at least one catalyst for crosslinking silane-functional polymers; and including a component B, including between 1 and 75 wt. % water dispersed in a mixture together with filler and/or plasticiser and further additives; and including further additives in component A and/or component B, from the group of fillers; wherein the catalyst is a tin complex having two mercaptide ligands according to formula (V), where ligands L1 independently represent sulfur-coordinated alkyl mercaptides, where ligands L1 include methyl dialkoxysilane groups, methyl dimethoxysilane groups, and ligands L2 independently represent alkyl ligands. The composition allows an exceptionally long pot time and simultaneously very rapid curing and excellent storage stability.

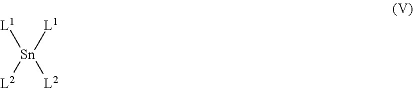

### TECHNICAL FIELD

The present invention relates to the field of two-component curable compositions based on organic polymers containing silane groups and to the use thereof, especially as adhesives.

### STATE OF THE ART

Compositions based on organic polymers containing silane groups have long been known and are used in a variety of ways. On contact with water or air humidity, these compositions are capable even at room temperature of condensing with one another under hydrolytic elimination of reactive groups on the silane groups, usually alkoxy groups, and simultaneous formation of silanols.

One of the most important applications of such materials is the production of adhesives and sealants, especially of elastic adhesive systems. They may alternatively be used as a coating or potting compound, and typically have not only good adhesion properties but also marked elasticity in the cured state. Thus, in particular, adhesives based on organic polymers containing silane groups in the cured state show not only very good adhesion properties on a wide variety of different substrates, but also very good mechanical properties, since they can be both tear-resistant and highly elastic. A further advantage of silane-crosslinking systems over many other adhesive and sealant technologies (for example over isocyanate-crosslinking systems) that is often mentioned is the substantial toxicological benignity of such polymers. In many applications, preference is given to one-component systems (1K systems) that cure only by contact with the air humidity diffusing inward. There additionally also exist two-component systems (2K systems) based on organic polymers containing silane groups, which consist of two components that are mixed before or during application. In these 2K systems, the reactive constituents containing silane groups, such as polymers containing silane groups and organosilanes, are usually packed in one component, while the second component contains water and any auxiliaries. On mixing, the reactive constituents containing silane groups then come into contact with the water in a homogeneous manner, which enables rapid, uniform curing irrespective of air humidity.

The crucial advantage of one-component systems is, in particular, the very user-friendly applicability thereof, since there is no need here for the user to mix different adhesive components. As well as being less time-consuming and laborious because no mixing is required and any dosage errors in the mixing of the components are reliably avoided, there is also no need in the case of one-component systems to process the adhesive or sealant within a usually quite narrow time window, as is the case, for example, for two-component systems (2K systems) on completion of mixing of the two components.

However, 1K systems have the crucial inherent disadvantage of curing only on contact with (air) humidity diffusing inward. In the case of deep joins and/or large-area bonds, this leads to extremely slow curing from the outside inward, the progress of which becomes ever slower as curing progresses owing to the increasingly long diffusion distances, and this is particularly marked in the case of thick adhesive or sealant layers. This is especially also true in the case of bonding of nonporous and/or water-repellent substrates (plastics, steel and other metal alloys, paint surfaces, glass and glazed surfaces etc.), where this problem cannot be reduced or solved even by prior uniform moistening of the bonding surface. The consequence of this, as well as slow curing, is low initial strength, which may even necessitate fixing of the parts to be bonded, but in any case makes it impossible to subject the bonding surface to full load over days or even weeks. In the case of corresponding joins and bonds, the use of 2K systems is thus advantageous or often even unavoidable.

Two-component compositions based on organic polymers containing silane groups are disclosed, for example, in EP 227 936 B1, EP 824 574 B1, WO 2008/153392 A1, and WO 2011/000737 A1. The 2K systems that are taught in these prior art documents comprise a first component that contains not only the organic polymers containing silane groups but also, for example, plasticizers, fillers, tin catalysts and further customary additives, for example stabilizers. A second component in the 2K system is typically a pasty, water-containing mixture containing, as well as water, typically chalk, thickeners, and optionally also further constituents such as plasticizers.

A particular disadvantage of these prior art 2K systems is that a compromise always has to be made between curing rate and processing time (pot life or open time) of the mixed composition. This is because, if reactivity in 2K systems is made very slow through use of comparatively unreactive catalysts, small amounts of catalyst or a small amount of water mixed in, in order to obtain a maximum processing time, curing after application on the other hand takes a comparatively long time, and there can additionally be problems with the curing. Thus, relatively small application errors (mixing errors) here can lead to distinct faults in the curing if, for example, too little water is present in the mixture.

Conversely, with high amounts of catalyst and water and/or particularly active catalysts such as alkyltin compounds, it is possible to achieve rapid curing of the mixed two-component composition, but this is at the expense of a user-friendly, sufficiently long processing time and is impracticable for many applications. A further disadvantage of conventional tin catalysts used in a high dose is the possible adverse effects of these catalysts on the storage stability of the corresponding components of the 2K systems.

There is therefore still a need for a storage-stable two-component composition based on polymers containing silane groups, which firstly has a sufficiently long processing time, independent of storage time, after mixing in order that it can be applied in a user-friendly manner, but thereafter cures very rapidly and in a faultlessly homogeneous manner and is not susceptible to mixing errors. Such a composition would be especially suitable for automated application. It would be particularly desirable if the processing time could be set within particular limits without any resultant adverse effect on the extremely rapid curing after the end of the processing time.

### SUMMARY OF THE INVENTION

It is therefore an object of the present invention to provide a two-component system based on polymers containing silane groups, which overcomes the disadvantages of the prior art and has a long pot life and cures very rapidly after the end of the pot life and has good mechanical properties after curing.

It has been found that, surprisingly, this object is achieved by two-component compositions as claimed in claim 1.

Through the use of a specific catalyst having two thiolate ligands, which is in no way obvious to the person skilled in the art, preferably in combination with specific organosilanes and an amine, it is possible to provide two-component compositions based on polymers containing silane groups that have a long pot life and can be used in broadly definable mixing ratios of the two components. The two-component compositions according to the invention have a robust mixing profile, i.e. they can be used with broadly selectable mixing ratios of component A and component B. In addition, the two-component compositions of the invention have exceedingly good storage stability. The two-component compositions of the invention, irrespective of the catalyst concentration, have a uniform pot life, which further increases flexibility with regard to the mixing ratio. Compared to the prior art, the compositions of the invention have at least the same or even better mechanical properties, and they have very good adhesion capacity on various substrates.

Further aspects of the invention are the subject of further independent claims. Particularly preferred embodiments of the invention are the subject of the dependent claims.

Ways of Executing the Invention

The present invention provides a two-component composition consisting of a component A comprising
i) at least one organic polymer STP containing silane groups;
ii) preferably at least one desiccant;
iii) preferably at least one amine AM having at least one free amino group or one latent amino group releasable via hydrolysis;
iv) optionally at least one hydrolyzable silane OS having no amino group; and
v) at least one catalyst K for the crosslinking of silane-functional polymers;
and a component B comprising
i) between 1% and 75% by weight of water, based on component B, where the water is preferably dispersed in a mixture with filler and/or plasticizer and optionally further additives;
and optionally, in component A and/or component B, further additives selected from the group consisting of fillers, hydrophilic or hydrophobic silicas, plasticizers, solvents, rheology additives, surfactants, pigments, emulsifiers, UV or oxidation stabilizers, flame retardants, biocides and non-moisture-reactive polymers or resins;
characterized in that
catalyst K is a tin complex of formula (V) that has two mercaptide ligands,

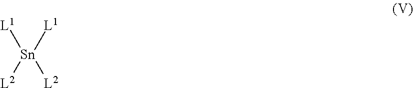

where ligands L¹ are each independently alkyl mercaptides coordinated via sulfur, especially C₆ to C₁₆ alkyl mercaptides, where ligands L¹ optionally have methyldialkoxysilane groups, preferably methyldimethoxysilane groups, and ligands L² are each independently alkyl ligands, especially C₆ to C₁₄ alkyl ligands.

In the present document, the term “silane group” refers to a silyl group which is bonded to an organic radical and has one to three, especially two or three, hydrolyzable radicals on the silicon atom. The hydrolyzable radicals are, for example, alkoxy, acetoxy, ketoximato, amido or enoxy radicals. Silane groups having alkoxy radicals are also referred to as “alkoxysilane groups”. Correspondingly, the term “silane” refers to an organic compound having at least one silane group.

“Epoxysilane”, “hydroxysilane”, “(meth)acrylatosilane”, “isocyanatosilane”, “aminosilane” and “mercaptosilane” refer respectively to silanes having one or more epoxy, hydroxyl, (meth)acrylate, isocyanato, amino and mercapto groups on the organic radical in addition to the silane group. “Primary aminosilanes” refer to aminosilanes having a primary amino group, i.e. an NH 2 group bonded to an organic radical. “Secondary aminosilanes” refer to aminosilanes having a secondary amino group, i.e. an NH group bonded to two organic radicals. “Hydrosilane” refers to a silicon-containing organic compound having at least one Si—H bond.

Silane equivalent weight is reported in g/equivalent or g/eq and can be calculated via the silicon content of a polymer containing silane groups which is determined by measurement in inductively coupled plasma (ICP). “Primary amino group” and “primary amine nitrogen” refer respectively to an NH 2 group and the nitrogen atom thereof that is bonded to an organic radical, and “secondary amino group” and “secondary amine nitrogen” refer respectively to an NH group and the nitrogen atom thereof that is bonded to two organic radicals which may also together be part of a ring, and “tertiary amino group” and “tertiary amine nitrogen” refer respectively to an N group and the nitrogen atom thereof that is bonded to three organic radicals, two or three of which together may also be part of one or more rings.

A heteroatom is understood to mean any heteroatom customary in organic chemistry, e.g. 0, N or S.

(Meth)acrylate means methacrylate or acrylate.

Substance names beginning with “poly”, such as polyol or polyisocyanate, refer to substances which, in a formal sense, contain two or more of the functional groups that occur in their name per molecule.

The term “polymer” in the present document firstly encompasses a collective of macromolecules that are chemically uniform but differ in relation to degree of polymerization, molar mass, and chain length, said collective having been prepared by a “poly” reaction (polymerization, polyaddition, polycondensation). The term also encompasses derivatives of such a collective of macromolecules from “poly” reactions, i.e. compounds obtained by reactions, for example additions or substitutions, of functional groups in defined macromolecules and which may be chemically uniform or chemically nonuniform. The term additionally also encompasses what are called prepolymers, i.e. reactive oligomeric preliminary adducts, the functional groups of which are involved in the formation of macromolecules.

A “prepolymer” is a polymer having functional groups that serves as a precursor for the formation of a higher molecular weight polymer.

The term “organic polymer” encompasses a collective of macromolecules that are chemically homogeneous but differs in degree of polymerization, molar mass and chain length and are therefore polydisperse, which has been produced by a poly reaction (polymerization, polyaddition, polycondensation), and has a majority of carbon atoms in the polymer backbone, and also reaction products of such a collective of macromolecules. Polymers having a polyorganosiloxane backbone (commonly referred to as “silicones”) are not organic polymers in the context of the present document.

The “polymer containing silane groups” as described in this document is always an organic polymer containing silane groups and having hydrolysis-reactive silane groups as defined further up. This term is also understood to be synonymous with the term “silane-functional polymer”. Polydiorganosiloxane polymers and especially polydimethylsiloxane polymers, also called silicone polymers, are therefore not polymers containing silane groups as defined in the present document. The term “polymer containing silane groups” thus refers to an organic compound bearing at least one silane group and having a linear or branched polymer chain comprising at least three coherent, identical or different structural units that derive from polymerizable monomers, for example alkylene oxides, (meth)acrylates or olefins. The polymer chain may, as well as the structural units mentioned, also contain functional groups, e.g. urethane groups and/or urea groups.

“Molecular weight” in the present document is understood as meaning the defined and discrete molar mass (in grams per mole) of a molecule or part of a molecule, also referred to as a “radical”. “Average molecular weight” denotes the number-average Mₙ of an oligomeric or polymeric mixture, especially a polydisperse mixture, of molecules or radicals, which is typically determined by gel-permeation chromatography (GPC) against a polystyrene standard.

A one-component composition comprises all constituents in one component. A multicomponent or two-component composition comprises two or more components, where one portion of the constituents is present in a first component and the other portion of the constituents in a second component or, if there are more than two components, in two or more further components, where the components are stored separately from one another. In the case of a multicomponent or two-component composition, the individual components are generally mixed with one another shortly before use.

A substance or composition is referred to as “storage-stable” or “storable” if it can be stored at room temperature in a suitable container for a prolonged period, typically of at least 6 months up to 9 months or longer, without storage resulting in any change in its application properties or use properties, particularly in the viscosity and crosslinking rate, to an extent relevant for the use thereof.

The term “pot life” or its synonym “open time” is understood to mean the window of processability of reactive compositions after application thereof. The end of the pot life is in most cases associated with a rise in the viscosity of the composition such that no further useful processing of the composition is possible.

A dotted line in the formulae in this document in each case represents the bond between a substituent and the corresponding remainder of the molecule. “Room temperature” refers to a temperature of approx. 23° C.

Unless otherwise stated, all industry standards or other standards mentioned in this document relate to the version of the industrial standard or other standard that was valid at the time of filing of the patent application.

The terms “mass” and “weight” are used synonymously in this document. Thus a “percentage by weight” (% by weight) is a percentage proportion by mass which, unless stated otherwise, refers to the mass (weight) of the overall composition or, depending on the context, of the entire molecule.

Component A

The first component A of the two-component composition contains at least one organic polymer STP containing silane groups;
preferably at least one desiccant;
preferably at least one amine AM having at least one free amino group or one latent amino group releasable via hydrolysis;
optionally at least one hydrolyzable silane having no amino group; and
at least one catalyst K for the crosslinking of silane-functional polymers.

Polymer STP Containing Silane Groups

The composition comprises, in component A, at least one polymer STP containing silane groups.

This is an organic polymer containing silane groups, especially one with a polymer backbone which is at least predominantly a polyolefin, poly(meth)acrylate or polyether or a mixed form of these polymers, and which bears one or preferably more than one silane group in each case. The silane groups may be pendant from the chain or terminal. In addition, the polymer containing silane groups may have one or more urethane or urea bonds in the polymer chain, and further organic radicals that arise, for example, from the reaction of polyols with diisocyanates.

Preferred polymers STP containing silane groups are the following polymers containing silane groups: polyethers, poly(meth)acrylates, polyolefins, polyesters, polyamides, polyurethanes and mixed forms of these polymers. Particular preference is given to silane group-containing polyethers, poly(meth)acrylates, polyolefins and polyesters, especially silane group-containing polyethers and poly(meth)acrylates. Most preferred are polyethers containing silane groups. In all these polymers, silane groups are preferably alkoxysilane groups.

In particular, the polymer STP containing silane groups is a polyether containing silane groups or consists of at least one polyether containing silane groups. “Polyether containing silane groups” is understood to mean a polymer containing silane groups that has a polymer backbone consisting predominantly of polyether units, but where it is likewise possible for one or more urethane, thiourethane, ester, amide and/or urea bonds, preferably urethane and/or urea bonds, to be present in the polymer chain, and also further organic radicals that arise, for example, from the reaction of polyols with isocyanates for chain extension, or those that originate from the synthetic attachment of the silane groups to the polymer.

Structural units present in the polymer chain of the polyether containing silane groups are oxyalkylene units, preferably oxy(C₂-C₄-alkylene) units, such as oxyethylene, oxypropylene or oxybutylene units, particular preference being given to oxypropylene units. The polymer chain may contain one type of oxyalkylene units or a combination of two or more different oxyalkylene units that may be distributed randomly or preferably arranged in blocks.

The polyether containing silane groups preferably has mainly oxyalkylene units, especially 1,2-oxypropylene units, in the polymer backbone.

The polymer STP containing silane groups is preferably liquid at room temperature.

It is possible to use one or more polymers STP containing silane groups, especially polyethers containing silane groups. The polymer STP containing silane groups, especially the polyether containing silane groups, contains at least one, preferably at least two, silane group(s). The polymer STP containing silane groups, especially the polyether containing silane groups, has an average of especially more than 1, preferably 1.3 to 4, preferably 1.5 to 3, more preferably 1.7 to 2.8, silane group(s) per molecule. The silane groups are preferably terminal.

The silane groups of the polymer STP, especially of the polyether containing silane groups, and preferably of the silanes likewise present in the composition, preferably have two or three, more preferably three, hydrolyzable radicals on the silicon atom. The hydrolyzable radicals may be the same or different; they are preferably the same.

The hydrolyzable radicals of all silane groups present in the composition are especially alkoxy, acetoxy, ketoximato, amido or enoxy radicals having 1 to 13 carbon atoms. Preference is given to alkoxy radicals. Preferred alkoxy radicals have 1 to 4 carbon atoms. Particular preference is given to methoxy and ethoxy radicals.

The silane groups of the polymer STP, especially of the polyether containing silane groups, and preferably of the silanes likewise present in the composition, are thus preferably alkoxysilane groups, especially dialkoxysilane groups and more preferably trialkoxysilane groups. Preference is further given to dimethoxysilane groups and diethoxysilane groups.

Preferred silane groups of the polymers STP containing silane groups, especially of the polyethers containing silane groups, and of the silanes likewise present in the composition are especially trimethoxysilane groups, dimethoxymethylsilane groups or triethoxysilane groups, and more preferably trimethoxysilane groups and triethoxysilane groups.

The polymer STP containing silane groups is preferably obtainable from
the copolymerization of (meth)acryloylsilanes with non-silane-functional (meth)acrylates and olefins, or
the grafting of polyolefins or poly(meth)acrylates with vinylsilanes or (meth)acryloylsilanes, or
the hydrosilylation of polymers having terminal allyl groups with hydrosilanes, or
the Michael-like reaction of polymers having terminal (meth)acryloyl groups with aminosilanes or mercaptosilanes, or
the reaction of polymers having silane groups from the copolymerization of alkylene oxides and epoxysilanes with polyisocyanates, or
the reaction of polymers having terminal hydroxyl groups, especially polyols or OH-terminated polyurethane prepolymers, with isocyanatosilanes, or
the reaction of polymers having terminal isocyanate groups, especially NCO-terminated polyurethane prepolymers (NCO prepolymers), with aminosilanes, hydroxysilanes or mercaptosilanes.

More preferably, the polymer STP containing silane groups is obtainable from the reaction of NCO prepolymers with aminosilanes or hydroxysilanes or mercaptosilanes.

Suitable NCO prepolymers are especially obtainable from the reaction of polyols with polyisocyanates, especially diisocyanates. This reaction can be effected by reacting the polyol and the polyisocyanate by customary methods, especially at temperatures of 50° C. to 100° C., optionally with additional use of suitable catalysts, especially amines or bismuth or zinc compounds, with metered addition of the polyisocyanate such that the isocyanate groups thereof are present in stoichiometric excess relative to the hydroxyl groups of the polyol. In particular, the chosen excess of polyisocyanate is such that, after reaction of all the hydroxyl groups in the polyol, the resulting polyurethane polymer has a residual content of free isocyanate groups of 0.1% to 5% by weight, preferably 0.2% to 3% by weight, based on the overall NCO prepolymer. Preference is given to NCO prepolymers having the stated content of free isocyanate groups that are obtained from the reaction of polyols with polyisocyanates in an NCO/OH ratio of 1.5/1 to 2.5/1, especially 1.8/1 to 2.2/1.

Suitable polyols for the preparation of the NCO prepolymer are standard polyols, especially polyether polyols, polyester polyols, polycarbonate polyols, poly(meth)acrylate polyols and polyolefin polyols, and mixed forms thereof. In addition to these polyols, it is possible also to use small amounts of di- or polyhydric alcohols of low molecular weight.

Suitable polyisocyanates for the preparation of the NCO prepolymer are standard polyisocyanates, especially diisocyanates, preferably hexamethylene 1,6-diisocyanate (HDI), 1-isocyanato-3,3,5-trimethyl-5-isocyanatomethylcyclohexane (=isophorone diisocyanate or IPDI), perhydro(diphenylmethane 2,4′- and 4,4′-diisocyanate) (HMDI or H₁₂MDI), tolylene 2,4- and 2,6-diisocyanate and any mixtures of these isomers (TDI), diphenylmethane 4,4′-, 2,4′- and 2,2′-diisocyanate and any mixtures of these isomers (MDI), and mixtures of these polyisocyanates.

The reaction of the NCO prepolymer with the aminosilane or hydroxysilane or mercaptosilane is preferably conducted in such a way that the amino or hydroxyl or mercapto groups of the silane are present at least stoichiometrically relative to the isocyanate groups of the NCO prepolymer. The polymer STP containing silane groups which is thus formed is free of isocyanate groups, which is advantageous from a toxicological point of view. The reaction is preferably effected at a temperature in the range from 20° C. to 120° C., especially 40° C. to 100° C.

Suitable aminosilanes for reaction of the NCO prepolymer are primary and secondary aminosilanes. Preference is given to secondary aminosilanes, especially N-butyl(3-aminopropyl)trimethoxysilane and N-ethyl(3-amino-2-methylpropyl)trimethoxysilane, and adducts of primary aminosilanes, especially 3-aminopropyltrimethoxysilane and N-(2-aminoethyl)-3-aminopropyltrimethoxysilane, and Michael acceptors, especially acrylates and maleic diesters, and analogs thereof with ethoxy rather than the methoxy groups. Particularly preferred aminosilanes are the adducts of 3-aminopropyltrimethoxysilane or 3-aminopropyltriethoxysilane and diethyl maleate.

Suitable hydroxysilanes for conversion of the NCO prepolymer are especially hydroxysilanes having a secondary hydroxyl group. The hydroxysilanes are preferably obtainable from
the reaction of epoxides with secondary aminosilanes, or
the reaction of epoxysilanes with secondary amines, or
the reaction of primary aminosilanes with lactones or cyclic carbonates.

Suitable mercaptosilanes for reaction of the NCO prepolymer are especially 3-mercaptopropylsilanes, preferably 3-mercaptopropyltrimethoxysilane and 3-mercaptopropyltriethoxysilane.

Suitable commercially available polymers containing silane groups are available, for example, under the following brand names: EPION® (from Kaneka; polyisobutylene containing silane groups), XMAP™ (from Kaneka, products SA100S, SA310S, SA420S; poly(meth)acrylate containing silane groups), Gemlac™ (from Kaneka; poly(meth)acrylate-silicone containing silane groups), Vestoplast® (from Evonik, products 206, EP2403, EP2412; amorphous poly-alpha-olefin containing silane groups), and also the polyethers containing alkoxysilane groups that are specified further down

The polymer STP containing silane groups, especially the polyether containing silane groups, preferably has an average molecular weight, determined by GPC against a polystyrene standard, in the range from 1′000 to 30′000 g/mol, especially from 2′000 to 20′ 000 g/mol.

The polymer STP containing silane groups, especially the polyether containing silane groups, preferably has a silane equivalent weight of 300 to 25′000 g/eq, especially of 500 to 15′000 g/eq.

The polymer STP containing silane groups, especially the polyether containing silane groups, preferably contains end groups of the formula (II)

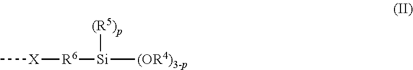

where
p has a value of 0 or 1 or 2, preferably 0 or 1, especially 0,
R⁴ is a linear or branched, monovalent hydrocarbyl radical having 1 to 5 carbon atoms,
R⁵ is a linear or branched, monovalent hydrocarbyl radical having 1 to 8 carbon atoms, especially methyl or ethyl,
R⁶ is a linear or branched, divalent hydrocarbyl radical which has 1 to 12 carbon atoms and which optionally contains cyclic and/or aromatic moieties and optionally one or more heteroatoms, especially one or more nitrogen atoms,
X is a divalent radical selected from —O—, —S—, —N(R⁷)—, —N(R⁷)—CO—, —O—CO—N(R⁷)—, —N(R⁷)—CO—O—, —N(R⁷)—CO—N(R⁷)—, —N(R⁷)—CO—O—CH(CH₃)—CO—N(R⁷)—, —N(R⁷)—CO—O—CH(R⁸)—CH₂—CH₂—CO—N(R⁷)— and —N(R⁷)—CO—O—CH(CH₃)—CH₂—O—CO—N(R⁷)—,
   where
   R⁷ is a hydrogen atom or is a linear or branched hydrocarbyl radical which has 1 to 20 carbon atoms and which optionally contains cyclic moieties, and which optionally contains an alkoxysilyl group or ether or carboxylic ester groups,
   and R⁸ is an unbranched alkyl radical having 1 to 6 carbon atoms, more particularly methyl.

Preferably R⁴ is methyl or is ethyl or is isopropyl.

More preferably, R⁴ is methyl. Such polymers STP containing silane groups are particularly reactive.

Also more preferably, R⁴ is ethyl. Such polymers STP containing silane groups are particularly storage-stable and toxicologically advantageous.

Preferably, R⁵ is methyl.

R⁶ is preferably 1,3-propylene or 1,4-butylene, wherein butylene may be substituted by one or two methyl groups.

R⁶ is more preferably 1,3-propylene.

Processes for producing polyethers containing silane groups are known to a person skilled in the art.

In one process, polyethers containing silane groups are obtainable from the reaction of polyethers containing allyl groups with hydrosilanes (hydrosilylation), optionally with chain extension using, for example, diisocyanates.

In another process, polyethers containing silane groups are obtainable from the copolymerization of alkylene oxides and epoxysilanes, optionally with chain extension using, for example, diisocyanates.

In a further process, polyethers containing silane groups are obtainable from the reaction of polyether polyols with isocyanatosilanes, optionally with chain extension using diisocyanates.

In a further process, polyethers containing silane groups are obtainable from the reaction of polyethers containing isocyanate groups, especially NCO-terminated urethane polyethers from the reaction of polyether polyols with a superstoichiometric amount of polyisocyanates, with aminosilanes, hydroxysilanes or mercaptosilanes. Polyethers containing silane groups from this process are particularly preferred. This process enables the use of a multitude of inexpensive starting materials of good commercial availability, by means of which it is possible to obtain different polymer properties, for example high stretchability, high strength, low glass transition temperature, or high resistance to hydrolysis.

Preferred polyethers containing silane groups are obtainable from the reaction of NCO-terminated urethane polyethers with aminosilanes or hydroxysilanes. NCO-terminated urethane polyethers suitable for this purpose are obtainable from the reaction of polyether polyols, especially polyoxyalkylenediols or polyoxyalkylenetriols, preferably polyoxypropylenediols or polyoxypropylenetriols, with a superstoichiometric amount of polyisocyanates, especially diisocyanates.

The reaction between the polyisocyanate and the polyether polyol is preferably carried out with exclusion of moisture at a temperature of 50° C. to 160° C., optionally in the presence of suitable catalysts, with the polyisocyanate being dosed such that the isocyanate groups contained therein are present in a stoichiometric excess in relation to the hydroxyl groups of the polyol. More particularly, the excess of polyisocyanate is chosen such that a content of free isocyanate groups in the range from 0.1% to 10% by weight, preferably 0.2% to 5% by weight, more preferably 0.3% to 3% by weight, based on the overall polymer, remains in the resulting urethane polyether after the reaction of all hydroxyl groups.

Preferred diisocyanates are selected from the group consisting of hexamethylene 1,6-diisocyanate (HU), 1-isocyanato-3,3,5-trimethyl-5-isocyanatomethylcyclohexane (=isophorone diisocyanate or IPDI), tolylene 2,4- and 2,6-diisocyanate and any desired mixtures of these isomers (TDI) and diphenylmethane 4,4′-, 2,4′- and 2,2′-diisocyanate and any desired mixtures of these isomers (MDI). Particular preference is given to IPDI or TDI. Most preferred is IPDI. In this way, polyethers containing silane groups with particularly good lightfastness are obtained.

Especially suitable as polyether polyols are polyoxyalkylenediols or polyoxyalkylenetriols having a degree of unsaturation lower than 0.02 meq/g, especially lower than 0.01 meq/g, and an average molecular weight in the range from 400 to 25′000 g/mol, especially 1′000 to 20′000 g/mol. As well as polyether polyols, it is also possible to use proportions of other polyols, especially polyacrylate polyols or polyester polyols, and also low molecular weight diols or triols.

Suitable aminosilanes for the reaction with an NCO-terminated urethane polyether are primary or secondary aminosilanes. Preference is given to 3-aminopropyltrimethoxysilane, 3-aminopropyldimethoxymethylsilane, 4-aminobutyltrimethoxysilane, 4-amino-3-methylbutyltrimethoxysilane, 4-amino-3,3-dimethylbutyltrimethoxysilane, N-butyl-3-aminopropyltrimethoxysilane, N-phenyl-3-aminopropyltrimethoxysilane, adducts formed from primary amino-silanes such as 3-aminopropyltrimethoxysilane, 3-aminopropyldimethoxymethylsilane or N-(2-aminoethyl)-3-aminopropyltrimethoxysilane and Michael acceptors such as acrylonitrile, (meth)acrylic esters, (meth)acrylamides, maleic or fumaric diesters, citraconic diesters or itaconic diesters, especially dimethyl or diethyl N-(3-trimethoxysilylpropyl)aminosuccinate. Likewise suitable are analogues of the recited aminosilanes having ethoxy or isopropoxy groups in place of the methoxy groups on the silicon.

Suitable hydroxysilanes for the reaction with an NCO-terminated urethane polyether are especially obtainable from the addition of aminosilanes onto lactones or onto cyclic carbonates or onto lactides.

Preferred hydroxysilanes of this kind are N-(3-triethoxysilylpropyI)-2-hydroxypropanamide, N-(3-trimethoxysilylpropyl)-2-hydroxypropanamide, N-(3-triethoxysilylpropyl)-4-hydroxypentanamide, N-(3-triethoxysilylpropyl)-4-hydroxyoctanamide, N-(3-triethoxysilylpropyI)-5-hydroxydecanamide or N-(3-triethoxysilylpropyl)-2-hydroxypropyl carbamate.

Further suitable hydroxysilanes are obtainable from the addition of aminosilanes to epoxides or from the addition of amines to epoxysilanes. Preferred hydroxysilanes of this kind are 2-morpholino-4(5)-(2-trimethoxysilylethyl)cyclohexan-1-ol, 2-morpholino-4(5)-(2-triethoxysilyl-ethyl)cyclohexan-1-ol or 1-morpholino-3-(3-(triethoxysilyl)propoxy)propan-2-ol.

Further suitable polyethers containing silane groups are commercially available products, especially the following: MS Polymer™ (from Kaneka Corp.; especially the 5203H, 5303H, S227, S810, MA903 and S943 products); MS Polymer™ or Silyl™ (from Kaneka Corp.; especially the SAT010, SAT030, SAT200, SAX350, SAX400, SAX725, MAX450, MAX951 products); Excestar® (from Asahi Glass Co. Ltd.; especially the S2410, S2420, S3430, S3630 products); SPUR+* (from Momentive Performance Materials; especially the 1010LM, 1015LM, 1050MM products); Vorasil™ (from Dow Chemical Co.; especially the 602 and 604 products); Desmoseal® (from Covestro; especially the S XP 2458, S XP 2636, S XP 2749, S XP 2774 and S XP 2821 products), TEGOPAC® (from Evonik Industries AG; especially the Seal 100, Bond 150, Bond 250 products), Polyvest® (from Evonik; especially the EP ST-M and EP ST-E products), Polymer ST (from Hanse Chemie AG/Evonik Industries AG, especially the 47, 48, 61, 61LV, 77, 80, 81 products); Geniosil ° STP (from Wacker Chemie AG; especially the E10, E15, E30, E35 products) or Arufon (from Toagosei, especially the US-6100 or US-6170 products).

The composition preferably has a content of polymer STP containing silane groups in the range from 5% to 80% by weight, more preferably in the range from 10% to 75% by weight, especially in the range from 15% to 70% by weight.

Desiccant

The composition of the invention may preferably further comprise, in component A, at least one desiccant. A desiccant stabilizes component A against premature unwanted curing, for instance in the container, and is advisable when the constituents of component A cannot be sufficiently dried in advance. The basis of this stabilizing effect is that unwanted water present is bound and/or reactively depleted by the desiccants and cannot hydrolyze the polymers STP. This is often necessary, for example, when fillers are used, in order to assure sufficient storage stability and constancy of properties over the course of prolonged storage.

In principle, suitable desiccants are all those used in the field of formulating compositions based on polymers containing silane groups.

Preferred examples of suitable desiccants are vinyltrimethoxysilane, vinyltriethoxysilane, vinylmethyldimethoxysilane, a-functional silanes such as O-(methylcarbamatomethyl)methyldimethoxysilane, 0-(methylcarbamatomethyl)trimethoxysilane, 0-(ethylcarbamatomethyl)methyldiethoxysilane, or 0-(ethylcarbamatomethyl)triethoxysilane, orthoformic esters, calcium oxide or molecular sieves.

Also suitable are oligomeric (partly condensed) forms of the silanes mentioned, and cocondensates with further different organosilanes are also suitable.

In preferred embodiments of the two-component composition according to the present invention, component A comprises a desiccant in an amount of between 1% by weight and 15% by weight, based on component A, where this desiccant is preferably a monomeric or oligomeric vinyl-functional silane or siloxane, especially an oligomeric vinyl-functional siloxane.

It is known that hydrolyzable organosilanes, as described, for example, as silanes OS further down, can quite generally also act as desiccants since they react with water and use up one water molecule per hydrolysis reaction. In the context of this invention, however, the only silanes that count as desiccants are those that are generally more reactive than the polymers STP in the composition. Such higher reactivity is typically achieved only by silanes containing vinyl groups or a-functional silanes. Other silanes in the context of this invention therefore count toward the silane OS as described further down, unless they have an amino group, even if they could also be effective as water scavenger.

Amine AM

Component A of the two-component composition preferably comprises at least one amine AM having at least one free amino group or one latent amino group releasable via hydrolysis.

The use of an amine AM in the composition leads to the benefit that a cocatalyst is thus present, which can especially catalyze the hydrolysis of the silane groups present. It is thus possible to distinctly accelerate the curing after mixing with component B and the presence of sufficient water.

In general, there is a rise in the reactivity and catalytic activity of the amine AM with the basicity of the amino group or amino groups present.

The amine AM may be an amine having a primary, secondary or tertiary amino group, or two or more such groups in any combination.

Amidines and guanidines are also suitable as amine AM.

In preferred embodiments of the two-component composition, the amine AM has at least one primary and/or one secondary amino group. Such amines are particularly suitable in terms of their reactivity in the two-component composition according to the invention.

Also suitable are amines AM that do not have a free amino group, but rather have a blocked, latent amino group releasable via hydrolysis. Such an embodiment has the benefit that the release reaction allows the amine AM likewise to act as a desiccant and improves storage stability, especially in the case of inadequately predried components A. In addition, it is also possible to use highly reactive and/or highly concentrated amines AM in latent form, which can be advantageous when particularly rapid curing is desired after mixing in water-containing component B, but the risk of inadequate storage stability is simultaneously to be avoided. It is also possible to use such amines with partly blocked amino groups.

Suitable amines AM having at least one latent amino group releasable via hydrolysis are, for example, amines wherein the amino group has been converted to a hydrolysis-labile imine with a ketone, or which have been reacted with an aldehyde to give an aldimine. There are no particular restrictions with regard to the manner of derivatization of the amine, provided that the free amine is formed on contact with water.

Component A of the two-component composition preferably has a content of amine AM in the range from 0.1% to 15% by weight, especially in the range from 0.2% to 10% by weight, based on component A. Such compositions cure particularly rapidly.

In preferred embodiments of the two-component composition according to the present invention, the amine AM comprises or consists of a silane AS containing amino groups.

A silane AS containing amino groups, as well as the at least one amino group, also contains at least one silane group which is incorporated into the polymer network as it forms in the course of curing. This has the benefit of preventing the amines AM from being sweated out after curing, and additionally improves adhesion to many substrates.

In preferred embodiments, the silane AS containing amino groups comprises at least one trialkoxysilane having an aminoalkyl radical which is bonded to the silicon atom and has primary and/or secondary amino groups, and/or comprises at least one organosilane of formula (IIa)

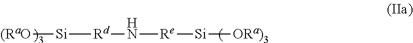

where R^{d} is a divalent linear or branched alkyl radical that has 2 to 10 carbon atoms and optionally contains a hydroxyl group and an ether oxygen; and R^{e} is a divalent linear or branched alkyl radical that has 2 to 10 carbon atoms and optionally contains a secondary amino group; and R^{a} is a hydrogen atom or a methyl or ethyl group.

A particularly preferred silane AS containing amino groups is especially selected from the group consisting of 3-aminopropyltrimethoxysilane, N-(2-aminoethyl)-3-aminopropyltrimethoxysilane, 3-amino-2-methylpropyltrimethoxysilane, 4-aminobutyltrimethoxysilane, 4-amino-3,3-dimethylbutyltrimethoxysilane, 3-aminopropyldimethoxymethylsilane, N-(2-aminoethyl)-3-aminopropyldimethoxymethylsilane and N-(2-aminoethyl)-N′-[3-(trimethoxysilyl)propyl]ethylenediamine, and also analogs thereof with ethoxy groups instead of the methoxy groups on the silicon.

Particularly preferred among these is 3-aminopropyltrimethoxysilane, 3-aminopropyltriethoxysilane, N-(2-aminoethyl)-3-aminopropyltrimethoxysilane or N-(2-aminoethyl)-3-aminopropyltriethoxysilane.

Additionally suitable as amine AM are, for example, also amino-functional alkylsilsesquioxanes such as amino-functional methylsilsesquioxane or amino-functional propylsilsesquioxane.

Also preferred are aminosilanes AS having at least one latent amino group releasable via hydrolysis. As is generally the case for amines AM having at least one latent amino group releasable by hydrolysis, such aminosilanes AS have the benefit that the amino group is not directly catalytically active for the hydrolysis of the silanes, but first has to be released hydrolytically. This enables a further extension of the pot life of the two-component composition of the invention, since the hydrolysis of the latent amino groups has to take place first.

Suitable aminosilanes AS having at least one latent amino group releasable via hydrolysis are, for example, aminosilanes wherein the amino group has been converted to a hydrolysis-labile imine with a ketone. Such aminosilanes AS are commercially available, for example 3-triethoxysilyl-N-(1,3-dimethylbutylidene)propylamine, a 3-aminopropyltriethoxysilane wherein the amino group has been reacted with 2-hexanone to give an imine and which is available under the KBE-9103P trade name from Shin Etsu.

Component A of the two-component composition preferably has a content of silane AS containing amino groups in the range from 0.1% to 15% by weight, especially in the range from 0.2% to 10% by weight, based on component A. Such compositions have high strength.

A high content of aminosilane AS enables a particularly high modulus of elasticity and particularly high strengths, and the silane group prevents unwanted migration effects and sweating-out of the amine.

Silane OS

Component A of the two-component composition also optionally further comprises at least one hydrolyzable silane OS having no amino group. Such additional silanes OS can bring various benefits. They can, for example, improved curing or, as crosslinker, improve mechanical properties by increasing the network density, or they can serve as adhesion promoter.

The definition of silane OS encompasses all hydrolyzable organosilanes that are not covered by aminosilane AS or embodiments of the desiccant described further up that contain silane groups.

The additional silane OS is especially a silane of the formula (III).

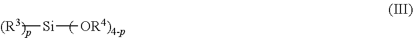

The radical R³ is here each independently a linear or branched, monovalent hydrocarbyl radical that has 1 to 12 carbon atoms and optionally includes one or more heteroatoms, and optionally one or more C—C multiple bonds and/or optionally cycloaliphatic and/or aromatic components.

The radical R⁴ is a radical R a as described hereinabove.

The index p has a value of 0 to 4, with the proviso that, if p has a value of 3 or 4, at least p-2 radicals R³ each have at least one group reactive, especially condensable, with the hydroxyl groups of the polydiorganosiloxane P, i.e. a hydroxyl group for example. In particular, p has a value of 0, 1 or 2, preferably a value of O.

Particularly suitable organosilanes OS are organosilanes that act as adhesion promoter. These are alkoxysilanes that have preferably been substituted by functional groups. The functional group is for example a glycidoxypropyl or mercaptopropyl group. The alkoxy groups of such silanes are preferably a methoxy or ethoxy group.

A suitable epoxy-functional silane is especially 3-glycidoxypropyltrimethoxysilane or 3-glycidoxypropyldimethoxymethylsilane or 3-glycidoxypropyltriethoxysilane.

A suitable mercapto-functional silane is especially 3-mercaptopropyltrimethoxysilane or 3-mercaptopropyldimethoxymethylsilane or 3-mercaptopropyltriethoxysilane.

Particular preference is given to 3-glycidoxypropyltrimethoxysilane, 3-glycidoxypropyltriethoxysilane, 3-mercaptopropyltrimethoxysilane and 3-mercaptopropyltriethoxysilane. It is also possible to use a mixture of organosilanes OS as adhesion promoters.

Examples of suitable silanes of the formula (III) are methyltrimethoxysilane, chloromethyltrimethoxysilane, ethyltrimethoxysilane, propyltrimethoxysilane, octyltrimetoxysilane, methyltriethoxysilane, phenyltriethoxysilane, methyltripropoxysilane, phenyltripropoxysilane, octyltriethoxysilane, tetramethoxysilane, tetraethoxysilane, tetra-n-propoxysilane or tetra-n-butoxysilane.

More preferably, the silane of the formula (III) is methyltrimethoxysilane, dimethyltrimethoxysilane or tetramethoxysilane or a mixture thereof, very particularly preferably methyltrimethoxysilane, propyltrimethoxysilane, octyltrimethoxysilane or mixtures thereof.

In addition, the silanes OS, and also the polymers STP and the other constituents containing silane groups that are present in component A, may also already be in partly (some of all the R⁴═H) or fully hydrolyzed form (all R⁴ ═H). The greatly enhanced reactivity of partly or fully hydrolyzed silanes means that the use thereof as crosslinkers may be advantageous. The person skilled in the art is here aware that the use of partly or fully hydrolyzed silanes can lead to the formation of oligomeric siloxanes, especially dimers and/or trimers, formed by condensation of hydrolyzed silanes. Accordingly, it is also possible to use oligomeric siloxanes as additives containing silane groups for the two-component composition.

Examples of suitable oligomeric siloxanes are hexamethoxydisiloxane, hexaethoxydisiloxane, hexa-n-propoxydisiloxane, hexa-n-butoxydisiloxane, octamethoxytrisiloxane, octaethoxytrisiloxane, octa-n-butoxytrisiloxane, decamethoxytetrasiloxane, and decaethoxytetrasiloxane.

Also suitable and preferred in the composition is at least one organosilane OS of the formula (VI)

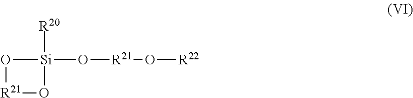

in which
R²⁰ is independently a monovalent, optionally cyclic or branched hydrocarbyl or heterocarbyl radical that optionally contains aromatic moieties and contains 1 to 12 carbon atoms, and in which the carbon atom next to the silicon atom is bonded either via a C═C double bond to another carbon atom or to a heteroatom selected from O, N and S;
R²¹ is independently a linear, cyclic or branched divalent hydrocarbyl radical which has 2 to 12 carbon atoms and optionally contains cyclic and/or aromatic units; and
R²² is a hydrogen atom or a group of the formula (Via)

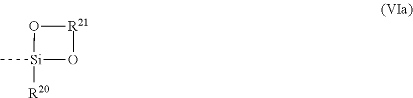

In preferred embodiments, each R²⁰ is independently a functional group selected from the group consisting of vinyl, phenyl, —CH₂—NH-cyclohexyl, —CH₂— methacrylate and —CH₂—NH—(C═O)—O—CH₃.

Most preferably, R²⁰ is vinyl.

In identical or different preferred embodiments, each R²¹ is a linear or branched divalent hydrocarbyl radical having 2 to 10 carbon atoms. Even more preferably, each R²¹ is independently selected from the group consisting of ethanediyl, the isomers of propanediyl, the isomers of butanediyl, the isomers of pentanediyl, the isomers of hexanediyl, cyclohexanediyl, the isomers of heptanediyl, the isomers of octanediyl and the isomers of nonanediyl. Particular preference is given to the isomers of pentanediyl, especially of 2,2-dimethylpropanediyl.

R²² is preferably a group of the formula (Via).

Suitable organosilanes OS of the formula (VII) and the preparation thereof are described in WO 2008/121360 A1. Suitable commercially available organosilanes OS are, for example, CoatOSil* T-Cure (Momentive) and

Silquest* Y-15866 (Momentive).

The silane OS used for the two-component composition may of course also be any desired mixture of the aforementioned silanes.

The proportion of the organosilane OS is preferably 0.1% to 25% by weight, especially 0.5% to 20% by weight, preferably 1% to 15% by weight, based on component A of the two-component composition.

Catalyst K

Component A of the two-component composition further comprises at least one catalyst K for the crosslinking of silane-functional polymers.

Catalyst K is a tin complex of formula (V) that has two mercaptide ligands

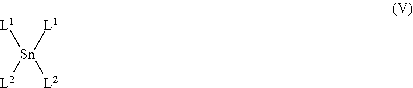

where ligands L¹ are each independently alkyl mercaptides coordinated via sulfur, especially C₆ to C₁₆ alkyl mercaptides, preferably C₈ to C₁₄ alkyl mercaptides, most preferably C₁₀ to C₁₂ alkyl mercaptides, where ligands L¹ optionally have methyldialkoxysilane groups, preferably methyldimethoxysilane groups, and ligands L² are each independently C₃ to C₁₈ alkyl ligands, especially C₆ to C₁₄ alkyl ligands, preferably C₆ to C₁₂ alkyl ligands.

Catalyst K is thus a Sn(IV) complex having two C₃ to C₁₈ alkyl ligands L², especially two C₆ to C₁₄ alkyl ligands L².

It has been found that very short alkyl ligands, such as methyl ligands, result in poor storage stability of the component A and are therefore unsuitable as ligand L².

Ligands L² are preferably C₆ to C₁₄ alkyl ligands, especially phenyl, hexyl, octyl or dodecyl ligands, most preferably octyl ligands. These form complexes that are particularly storage-stable and that in the composition achieve particularly good activity according to the invention.

In addition, catalyst K has two mercaptide ligands L¹ coordinated via the sulfur atoms, especially C₆ to C₁₆ alkyl mercaptides, where ligands L¹ optionally have methyldialkoxysilane groups, preferably methyldimethoxysilane groups. The term mercaptide is used synonymously with the term thiolate and describes deprotonated RS⁻ ligands where R is an organic radical.

It has been found that the two ligands L¹ cannot constitute a single bidentate ligand having two thiolate groups, since the chelating effect can decrease the effect achieved by the invention. Ligands L¹ must therefore be two individually coordinated alkyl mercaptide ligands. It is preferable that these ligands do not have any other heteroatoms that can be coordinated to tin, such as amino or carboxylate groups. Preferably, ligands L¹ contain no functional groups having heteroatoms, aside from methyldialkoxysilane groups.

Methyldialkoxysilane groups, especially methyldimethoxysilane groups, can on the other hand be advantageous since they can be incorporated into the polymer backbone, thereby limiting the mobility of the sulfur ligands. This has the advantage that undesired migration effects and/or any yellowing are prevented. However, it is preferable when the methylalkoxysilane groups, if present, have the same alkoxysilane groups as the polymers STP and/or any organosilanes OS present.

Furthermore, ligands L¹ having trialkoxysilane groups have been found to be unsuitable, since they decrease the effectiveness of the catalyst and the storage stability of the composition.

Ligands L¹ are preferably dodecylthiolate ligands, octadecylthiolate ligands, or 3-mercaptopropylmethyldimethoxysilane ligands coordinated via the sulfur atom.

Particular preference is given to dodecylthiolate ligands. These result in a particularly effective, particularly storage-stable catalyst K. Dodecylthio ligands have the further advantage of having a barely perceptible odor compared to ligands having shorter alkyl chains, but still being liquid at room temperature and therefore easy to handle compared to ligands having longer alkyl chains. Particular preference is further given to 3-mercaptopropylmethyldimethoxysilane ligands coordinated via the sulfur atom.

These result in a particularly effective catalyst K and a particularly low tendency to yellowing in the cured composition.

In a particularly preferred embodiment of catalyst K, in the formula (V) both ligands L¹ are dodecyl mercaptide and both ligands L² are octyl.

In a further particularly preferred embodiment of catalyst K, in the formula (V) both ligands L¹ are 3-mercaptopropylmethyldimethoxysilane and both ligands L² are octyl.

Catalysts K can be easily prepared, for example by stirring dialkyltin diacetates with the appropriate mercaptan ligands in a molar ratio (ligand: tin complex) of approximately 2:1 with exclusion of air for 24 h at 23° C. By-products formed by ligand exchange, such as acetic acid, can advantageously be removed, for example by distillation under reduced pressure.

It is of course possible or in some cases even preferable to use mixtures of different catalysts.

The proportion of the catalyst K for the crosslinking of polydiorganosiloxanes is preferably 0.05% to 10% by weight, especially 0.1% to 5% by weight, preferably 0.25% to 4% by weight, based on component A of the two-component composition.

In the two-component compositions of the invention, components A, as well the polymer STP containing silane groups and the catalyst K, preferably also contain desiccants, amine AM and optionally additionally also silanes OS, and further customary auxiliaries and additives.

Component B

The second component B of the two-component composition contains at least between 1% and 75% by weight of water, based on component B, where the water is preferably dispersed in a mixture with filler and/or plasticizer and optionally further additives.

Water

Component B of the two-component composition comprises between 1% by weight and 75% by weight, especially between 5% by weight and 70% by weight, preferably between 10% by weight and 60% by weight, more preferably between 25% by weight 50% by weight, of water, preferably emulsified water, based on component B.

Water in component B leads to rapid uniform curing of the mixed two-component composition and is essential in order to enable rapid and homogeneous curing, particularly in deeper layers, in accordance with the invention. More preferably, water is present in an amount of between 30% by weight and 50% by weight, based on component B.

The water is preferably present not in free form or in the form of adsorbed water (for instance on fillers), but as an emulsion or macroscopically homogeneous mixture (for example together with plasticizers). This permits more homogeneous mixing into component A with low concentration gradients and, after application, more uniform curing of the mixed composition. Advantageous mixtures have been found to be, for example, those comprising plasticizers, especially polyether polyols, and fillers, especially chalk, and hydrophilic silicas, where these mixtures more preferably have a water content of between 30% by weight and 50% by weight, based on all mixture components.

Component B is especially a water-containing paste in which the water present is thickened by at least one carrier material, typically selected from the group consisting of a plasticizer, a thickener and a filler.

The water content in component B can be varied depending on the embodiment of component A. It will of course be clear to the person skilled in the art that the amount of component B used is dependent on the amount of water present therein. Thus, for example, if component B contains a high water content of >50% by weight, component B is typically used in an amount of 1 to 10% by weight, based on the amount of component A. If component B, by contrast, contains only about 5% by weight of water, for example, component B may also be used in an amount of about 50% by weight based on the amount of component A.

The water content in the overall two-component composition is preferably in such a range that 50% to 100% of all moisture-reactive groups in the composition can be reacted with the water present. But it is also possible to use, without any problem and possibly advantageously, an excess of water of, for example, twice the molar amount of water based on all the hydrolyzable silane groups present in component A. In the case of a molar deficiency of water, the material will continue to cure by virtue of air humidity diffusing inward, whereas, in the case of an excess, the water will remain in the cured compound or gradually diffuse out.

Component B of the two-component composition of the invention, in addition to water, preferably contains plasticizers and fillers.

The plasticizers, as described further down, are preferably used in concentrations of 5-95% by weight, preferably 10-75% by weight, based on the total weight of component B.

In addition, component B may also contain fillers, as described further down, in concentrations of preferably 5-70% by weight, more preferably 30-60% by weight, based in each case on the total weight of component B.

In addition, component B may contain thickeners. These are preferably water-soluble or water-swellable polymers, or inorganic thickeners. Examples of organic thickeners include starch, dextrins, oligosaccharides, cellulose, cellulose derivatives such as carboxymethylcellulose, cellulose ethers, methylcellulose, hydroxyethylcellulose or hydroxypropylcellulose, agar-agar, alginates, pectins, gelatin, carrageenan, tragacanth, gum arabic, casein, polyacrylamide, poly(meth)acrylic acid derivatives, polyvinylethers, polyvinylalcohols, polyamides or polyimines.

The preferred amounts of the thickeners are 0-10% by weight, based on the total weight of component B.

Thickening can also be accomplished using thickening organic fillers.

Examples of thickening inorganic fillers are polysilicas, fumed silicas, aluminosilicates or clay minerals.

In addition, it is possible to add further rheology additives as described further down.

It is likewise preferable to use surfactants, emulsifiers or further mixture stabilizers in component B, since this affords a mixture which is homogeneous over a prolonged period without separation.

Additives

The two-component composition may optionally contain further constituents in one or both of components A and B. Such further additives are selected from the group consisting of fillers, hydrophilic or hydrophobic silicas, plasticizers, solvents, rheology additives, surfactants, pigments, emulsifiers, UV or oxidation stabilizers, flame retardants, biocides and non-moisture-reactive polymers or resins.

When such optional constituents are used, it is important to ensure that constituents that could decrease the storage stability of the composition by reacting with one another or with other ingredients are stored separately from one another.

It is possible for at least one or two or more of these optional additives to be present in the composition, or if appropriate a combination of all the additives mentioned. The optional additives are elucidated in detail hereinafter.

These additives can improve the processability and miscibility of component A and/or of component B and/or of the mixed two-component composition, or they can improve the mechanical properties, storage stability or curing characteristics. However, they are not essential to the effect of the invention.

The composition of the invention may also preferably comprise at least one rheology additive, for example a urea compound, a polyamide wax or a fumed silica.

Rheology additives used may, for example, be thixotropic agents. Examples include polyamide waxes, hydrogenated castor oils, stearate salts or urea derivatives.

Certain fillers may also be utilized for adjustment of the flow properties, for example hydrophilic fumed silicas, coated hydrophobic fumed silicas, precipitated silicas and precipitated chalks.

The composition of the invention may also preferably comprise at least one plasticizer, either in component A, in component B, or in both components. Preferred examples of suitable plasticizers are esters of organic carboxylic acids or anhydrides thereof, such as phthalates, especially diisononyl phthalate or diisodecyl phthalate, hydrogenated phthalates, especially diisononyl cyclohexane-1,2-dicarboxylate, adipates, especially dioctyl adipate,azelates and sebacates, polyols, especially polyoxyalkylene polyols or polyester polyols, organic phosphoric and sulfonic esters, or polybutenes.

It is also advantageous to select all the constituents mentioned that are optionally present in the two-component composition such that the storage stability of the two components of the two-component silicone composition is not adversely affected by the presence of such a constituent, meaning that there is little or no change in the properties of the composition, especially the application and curing properties, during storage. This means that reactions that lead to chemical curing of the described two-component composition do not occur to a significant degree during storage. It is therefore especially advantageous when the constituents mentioned in component A contain, or release during storage, no water or at most traces thereof. It may therefore be advisable for certain constituents to undergo chemical or physical drying before being mixed into the composition.

Preferably, the composition also includes at least one filler in one or both of components A and B, especially in component A and component B. The filler influences both the rheological properties of the uncured composition and the mechanical properties and surface characteristics of the cured composition. It is possible to use either active or passive fillers in the two-component composition. In the case of active fillers, chemical or physical interactions with the polymer occur; in the case of passive fillers, these occur only to a minor degree, if at all.

Suitable fillers are inorganic and organic fillers, for example natural, ground or precipitated calcium carbonates that have optionally been coated with fatty acids, especially stearic acid, or coated in some other way, calcined kaolins, aluminum oxides, aluminum hydroxides, magnesium hydroxide, mixed hydroxides of magnesium and aluminum, silicas, especially finely divided silicas from pyrolysis processes, industrially produced carbon black, aluminum silicates, magnesium aluminum silicates, zirconium silicates, ground quartz, ground cristobalite, diatomaceous earth, mica, iron oxides, titanium oxides, zirconium oxide, gypsum, annalin, barium sulfate (BaSO₄, also called baryte or heavy spar), boron carbide, boron nitride, graphite, carbon fibers, carbon particles, especially carbon nanotubes, glass fibers or hollow glass beads, the surface of which may have been treated with a hydrophobizing agent. Preferred fillers are calcium carbonates, calcined kaolins, finely divided silicas, and flame-retardant fillers such as hydroxides or hydrates, especially hydroxides or hydrates of aluminum, preferably aluminum hydroxide.

In a preferred embodiment, the composition contains, as filler, finely divided silicas from pyrolysis processes or precipitated and/or ground calcium carbonates, especially ones having a hydrophobic coating.

Component A preferably contains at least one filler, especially precipitated and/or ground, preferably hydrophobically coated, calcium carbonates. Component A preferably contains finely divided silicas from pyrolysis processes. Component A contains less than 5% by weight of carbon black, based on component A. In some preferred embodiments, component A does not contain any carbon black. Carbon black may under some circumstances influence the inventive effect of the catalyst K, particularly if carbon black is present in component A, since it can possibly interact with the thiolate ligands of catalyst K. This can result in shortening of the pot life. However, it is entirely possible to use carbon black, in which case the amount of catalyst K and/or of the amines AM should be adjusted if necessary. It is merely advisable first to evaluate the influence of the desired amount of carbon black on pot life in any case as a matter of routine.

It is entirely possible and may even be advantageous to use a mixture of different fillers.

A suitable amount of filler is, for example, in the range from 10% to 80% by weight, especially 15% to 70% by weight, preferably 30% to 60% by weight, based on the overall two-component composition.

The composition of the invention may further comprise, in one or both components, at least one stabilizer against oxidation, heat, light and UV radiation.

Stabilizers used may, for example, be antioxidants or light stabilizers, such as what are called HALS stabilizers, sterically hindered phenols, thioethers or benzotriazole derivatives.

In addition, the composition may also contain, in one or both components, fungicides, biocides, flame retardants, pigments etc.

It is preferable that the two-component composition of the invention is free of compounds containing isocyanate groups. The isocyanate group includes free and blocked isocyanate groups. In particular, the polymer STP containing silane groups preferably does not have any isocyanate group. The polymer STP containing silane groups is also preferably free of alcoholic OH groups bonded to a carbon atom.

A particularly preferred embodiment of component A of the composition of the invention comprises, based in each case on the overall component A, between 10% by weight and 50% by weight of organic polymer STP containing silane groups; and
between 25% by weight and 60% by weight of fillers; and
between 0.1% by weight and 15% by weight of amine AM; and
between 0.1% by weight and 15% by weight of desiccant; and
between 0.1% and 15% by weight of hydrolyzable silane OS having no amino group; and
between 5% by weight and 25% by weight of plasticizer; and
between 0.1% and 5% by weight of catalyst K; and
optionally further additives selected from the group consisting of fillers, hydrophilic or hydrophobic silicas, plasticizers, solvents, rheology additives, surfactants, pigments, emulsifiers, UV or oxidation stabilizers, flame retardants, biocides and non-moisture-reactive polymers or resins,

with the proviso that the respective amounts are selected such that they all add up to 100% by weight.

A particularly preferred embodiment of component B of the composition of the invention comprises, based in each case on the overall component B,
between 5% by weight and 60% by weight of water, preferably dispersed water; and
between 5% by weight and 20% by weight of silica, preferably hydrophilic silica; and
between 20% by weight and 60% by weight of plasticizer, preferably polyether-based plasticizer; and
optionally further additives selected from the group consisting of fillers, hydrophilic or hydrophobic silicas, plasticizers, solvents, rheology additives, surfactants, pigments, emulsifiers, UV or oxidation stabilizers, flame retardants, biocides and non-moisture-reactive polymers or resins,

with the proviso that the respective amounts are selected such that they all add up to 100% by weight.

More particularly, the two-component composition of the invention is used such that the weight ratio of component A to component B on mixing is 1:1, especially from 10:1 to 60:1, 10:1 to 50:1, preferably from 15:1 to 50:1.

In the two-component composition of the invention, components A and B are typically stored in separate packages or in one package having two separate chambers. Component A is here present in one chamber and component B in the other chamber of the package. Examples of suitable packages are double cartridges, such as twin or coaxial cartridges, or multichamber tubular pouches with adapters. Preference is given to mixing the two components A and B with the aid of a static mixer that can be fitted onto the package having two chambers.

Such suitable packages are described for example in US 2006/0155045 A1, WO 2007/096355 A1 and in US 2003/0051610 A1.

In an industrial-scale plant, the two components A and B are typically stored separately from one another in vats or hobbocks, and expressed and mixed on application, for example by means of gear pumps. The composition may here be applied to a substrate manually or in an automated process by means of a robot.

The use of the composition of the invention in the form of a two-component composition has the benefit that the chemical crosslinking of the silane groups in the composition via direct mixing-in of the water-containing component B proceeds more quickly and hence faster strength is built up and the composition cures through more quickly. A further benefit is that the curing may be independent of the air humidity of the environment.

Especially component B of the above-described two-component composition is produced and stored with exclusion of moisture. If kept apart from one another, the two components are storage-stable, meaning that they can be stored with exclusion of moisture in a suitable package or arrangement as described above over a period of several months to up to a year or longer without any change in their use properties or in their properties after curing to an extent relevant to their use. Typically, the storage stability is determined by measuring the viscosity or reactivity over time.

In the application of the two-component composition, components A and B are mixed together, for example by stirring, kneading, rolling or the like, but especially by means of a static mixer. When this is done, the hydrolyzable silane groups of the polymer STP containing silane groups in component A comes into contact with water from component B, which results in curing of the composition through condensation reactions, initially with formation of silanol groups. The two-component composition is especially cured at room temperature, but this can also be accelerated by heating.

Reaction products of the condensation reaction that are formed in the crosslinking of the two-component composition are in particular also compounds of the formula HO—R^{a}, where R^{a} has already been described above. Preferably, these by-products of the condensation reaction are compounds that adversely affect neither the composition nor the substrate to which the composition is applied. Most preferably, the reaction product of the formula HO—R^{a} is a compound which is readily volatilized out of the crosslinking or already crosslinked composition.

The invention further relates to a cured composition as obtainable from an above-described two-component composition by mixing component A with component B.

The invention further relates to the use of two-component compositions as described above as adhesive, sealant, as coating or as casting compound. Preference is given to using the composition of the invention as adhesive.

The two-component composition of the invention is especially used in a method of bonding two substrates S1 and S2, comprising the steps of
a) applying a two-component composition as described above to a substrate S1 and/or a substrate S2;
b) contacting substrates S1 and S2 via the applied composition within the open time of the composition;
c) curing the composition by reaction of components A and B;

wherein substrates S1 and S2 are the same or different.

Preference is also given to using the composition of the invention in a method of sealing or coating, comprising the steps of
a′) applying a two-component composition as described above to a substrate S1 and/or between two substrates S1 and S2;
b′) curing the composition by reaction of components A and B;

wherein substrates S1 and S2 are the same or different.

It will of course be clear to the person skilled in the art that the two components A and B must be mixed together immediately before or during application of the two-component composition.

Component A would cure gradually even without component B as soon as air humidity reaches the exposed component A. However, this form of curing is significantly slower than that according to the invention, and homogeneous, uniform depth curing is achieved only after a long time, if at all, since the curing mechanism is limited by the inward diffusion of moisture.

The two-component composition of the invention preferably has a pasty consistency with structurally viscous properties. Such a composition is applied to the substrate with a suitable device, preferably in the form of a bead, which advantageously has an essentially round or triangular cross-sectional area. A composition of the invention with good application properties has high creep resistance and forms short threads. This means that after application it remains in the shape applied, i.e. does not flow away, and after the application device has been pulled away forms only a very short thread, if any, so that the substrate is not contaminated.

Suitable substrates S1 and/or S2 are especially substrates selected from the group consisting of concrete, mortar, brick, tile, ceramic, gypsum, natural stone such as granite or marble, glass, glass ceramic, metal or metal alloys such as aluminum, steel, nonferrous metal, galvanized metal, wood, plastics such as PVC, polyethylene, polyamide, polymethyl(meth)acrylate, polyester, epoxy resin, paint, and varnish.

The two-component composition finds use especially in industrial manufacturing, especially of vehicles and consumer articles for everyday use, and also in the construction sector, especially in civil engineering below and above ground.

Preference is given to using the two-component composition in industrial manufacture.

In addition, the invention relates to an article including at least one partly cured composition as described above, said article especially being a built structure, an industrial good or a mode of transport, especially an industrially manufactured good or a part thereof.

An illustrative enumeration of such articles comprises houses, glass façades, windows, baths, bathrooms, kitchens, roofs, bridges, tunnels, roads, automobiles, trucks, rail vehicles, buses, ships, mirrors, panes, tanks, white goods, domestic appliances, dishwashers, washing machines, ovens, headlamps, foglights or solar panels.

After the end of the extremely long pot life, the composition cures unexpectedly rapidly and very uniformly. Irrespective of the chosen mixing ratio and the amount of catalyst present, provided that sufficient water is mixed in, the pot life and the final properties, especially mechanical properties, of the cured composition are largely the same. This is extremely advantageous and allows a user to have great flexibility in the adjustment of the mixing ratio. At the same time, mixing errors are forgiven.

The composition of the invention barely increases in viscosity during the pot life, and does so to a much smaller degree than traditionally catalyzed compositions based on polymers containing silane groups.

However, the composition of the invention cures exceedingly rapidly and almost instantly after the end of the pot life, while prior art compositions that are not catalyzed in accordance with the invention begin to cure uniformly but more slowly even after mixing.

In the compositions of the invention, by contrast, the viscosity remains comparatively low throughout the pot life. This enables very efficient process control, since the composition thus remains pumpable and conveniently applicable and cures extremely rapidly after application, and the substrate to which the composition has been applied can immediately be processed further or transported.

By contrast, prior art two-component compositions typically have either a very long pot life and at the same time a very long curing time, or else very rapid curing along with an extremely short, user-unfriendly pot life. The present invention permits establishment of long or short pot lives as required, but in all cases permits very rapid curing after application.

### EXAMPLES

Working examples are adduced hereinafter, which are intended to further elucidate the invention described.

Substances Used

TABLE 1
Substances used

| | |
|---|---|
| Silquest A-171 | Silquest ® A-171 (Momentive); vinyltrimethoxysilane |
| Silquest A-1110 | Silquest ® A-1110 (Momentive); 3- |
| | aminopropyltrimethoxysilane |
| Dynasylan 1189 | Dynasylan ® 1189 (Evonik); n- |
| | butylaminopropyltrimethoxysilane |
| Silquest A-1170 | Silquest ® A-1170 (Momentive); |
| | bis(trimethoxysilylpropyl)amine |
| Dynasylan PTMO | Dynasylan ® PTMO (Evonik); propyltrimethoxysilane |
| KBE-9103P | KBE-9103P (Shin Etsu); 3-triethoxysilyl-N-(1,3 |
| | dimethylbutylidene)propylamine |
| Acclaim 4200 | Acclaim ® 4200 (Covestro); linear polypropylene |
| | glycol-diol (polyether polyol) (plasticizer) |
| Acclaim 12200 | Acclaim ® 12200 (Covestro); linear polypropylene |
| | glycol-diol (polyether polyol) (plasticizer) |
| DINCH | Hexamoll ® DINCH (BASF); diisononyl |
| | cyclohexane-1,2-dicarboxylate (plasticizer) |
| Aerosil 200 | Aerosil ® 200 (Evonik); hydrophilic fumed silica |
| Socal | Socal ® U1S2 (Solvay); surface-coated precipitated |
| | chalk |

Preparation of the polymer STP-1 containing silane groups

1000 g of Acclaim® 12200 polyol (from Covestro; low-monool polyoxypropylenediol, OH value 11.0 mg KOH/g, water content approx. 0.02% by weight), 43.6 g of isophorone diisocyanate (Vestanat® IPDI from Evonik Industries), 126.4 g of diisodecyl phthalate, and 0.12 g of dibutyltin dilaurate were heated to 90° C. with exclusion of moisture and with continuous stirring and maintained at this temperature until the content of free isocyanate groups as determined titrimetrically had reached a value of 0.63% by weight. 62.3 g of diethyl N-(3-trimethoxysilylpropyl)aminosuccinate was then mixed in and the mixture was stirred at 90° C. until free isocyanate was no longer detectable by FT-IR spectroscopy. The resultant polymer STP-1 containing silane groups was cooled down to room temperature and stored with exclusion of moisture.

Description of catalysts K1 to K3 The following commercially available catalysts of formula (V) were used: catalysts K1 and K3 are inventive; catalyst K2 is a reference example. Table 2 defines the ligands of these catalysts as specified in formula (V).
K1: Fomrez® UL-32 (Galata Chemicals)
K2: TIB KAT ° 218 (TIB Chemicals)
K3: Fomrez® UL-22 (Galata Chemicals)

TABLE 2
Catalysts K1 to K4 used. The columns describe the ligands L¹ and
L² of formula (V). All catalysts are tetracoordinate tin catalysts.

| Catalyst | L¹ | L¹ | L² | L² |
|---|---|---|---|---|
| K1 | 1-Dodecanethiolate | 1-Dodecanethiolate | Octyl | Octyl |
| K2 | Dodecanoate | Dodecanoate | Butyl | Butyl |
| K3 | 1-Dodecanethiolate | 1-Dodecanethiolate | Methyl | Methyl |

Production of the Example Compositions

For each composition, the ingredients of the first component A specified in the tables were processed in the specified amounts (in parts by weight or % by weight), by means of a vacuum dissolver with the exclusion of moisture, to give a homogeneous paste and stored. The ingredients of the second component B specified in the tables were likewise processed and stored. The two components were then processed for 30 seconds, by means of a SpeedMixer® (DAC150 FV, Hauschild), into a homogeneous paste, which was immediately tested as follows:

To determine the mechanical properties, the adhesive was converted to dumbbell form according to ISO 527, Part 2, 1B, and cured at 23° C. and 50% rh (relative humidity) for 7 days.

After a conditioning period of 24 h at 23° C. and 50% rh, the modulus of elasticity in the 0 to 100% elongation range, the tensile strength, and the elongation at break of the test specimens thus produced were measured in accordance with DIN EN ISO 527 on a Zwick Z020 tensile tester at 23° C. and 50% rh and a testing speed of 10 mm/min.

The pot life was measured in a viscometer as the time until the viscosity began to rise steeply after mixing the two components. What was measured was specifically the time before the viscosity of the mixture had risen to 1000 Pa·s. Also observed was whether the rise in viscosity was continuous (K) or instant (S), with observation in the latter case of a “hockey stick” shape of the viscosity curve (with a relatively flat rise at the start and a distinctly faster rise toward the end of the measurement range examined of 0-1000 Pas). Viscosity was measured in a time-resolved manner on an MCR302 parallel-plate rheometer (Anton Paar) with a plate diameter of 25 mm and a plate distance of 1 mm at a frequency of 0.1 s⁻¹ and a temperature of 20° C. This was done by first mixing the two components for 30 sec in a SpeedMixer (Hauschild) and immediately applying them to the plates for the measurement.

TABLE 3
Experiments R-1 to R-3 (reference experiments)
and I-1 to I-2 (inventive).

| | | | | | |
|---|---|---|---|---|---|
| Example | R-1 | R-2 | R-3 | I-1 | I-2 |

First component A (amounts in parts by weight)

| | | | | | |
|---|---|---|---|---|---|
| Polymer STP-1 containing silane | 82.7 | 85.4 | 82.7 | 82.7 | 82.7 |
| groups | | | | | |
| Silquest A-171 | 5.5 | 2.75 | 5.5 | 5.5 | 5.5 |
| Silquest A-1110 | 4.15 | 4.15 | — | 4.15 | 4.15 |
| Dynasylan 1189 | — | — | 4.15 | — | — |
| Catalyst K1 | — | — | — | 0.31 | 0.62 |
| Catalyst K2 | 0.31 | 0.31 | 0.31 | — | — |
| DINCH | 7.4 | 7.4 | 7.4 | 7.4 | 7.1 |

Second component B (amounts in parts by weight)

| | | | | | |
|---|---|---|---|---|---|
| Water | 40 | 40 | 40 | 40 | 40 |
| Aerosil 200 | 10 | 10 | 10 | 10 | 10 |
| Acclaim 12200 | 50 | 50 | 50 | 50 | 50 |

Properties of the mixture of the two components A and B

| | | | | | |
|---|---|---|---|---|---|
| Mixing ratio A:B (by weight) | 17.2 | 24 | 17.2 | 17.2 | 17.2 |
| Rise in viscosity during pot life | K | K | K | S | S |
| (continuous (K) or instant (S)) | | | | | |
| Pot life [min] | 13 | 6 | 16 | 34 | 33 |

TABLE 4
Experiments I-3 to I-7 (inventive).

| | | | | | |
|---|---|---|---|---|---|
| Example | I-3 | I-4 | I-5 | I-6 | I-7 |

First component A (amounts in parts by weight)

| | | | | | |
|---|---|---|---|---|---|
| Polymer STP-1 containing silane | 82.7 | 82.7 | 82.7 | 82.7 | 82.7 |
| groups | | | | | |
| Silquest A-171 | 5.5 | 5.5 | 5.5 | 5.5 | 5.5 |
| Silquest A-1110 | — | 4.15 | 4.15 | 4.15 | 4.15 |
| Silquest A-1170 | 4.15 | — | — | — | — |
| Catalyst K1 | 0.62 | — | — | 0.1 | 1.2 |
| Catalyst K3 | — | 0.31 | 0.1 | — | — |
| DINCH | 7.1 | 7.4 | 7.6 | 7.6 | 6.5 |

Second component B (amounts in parts by weight)

| | | | | | |
|---|---|---|---|---|---|
| Water | 40 | 40 | 40 | 40 | 40 |
| Aerosil 200 | 10 | 10 | 10 | 10 | 10 |
| Acclaim 12200 | 50 | 50 | 50 | 50 | 50 |

Properties of the mixture of the two components A and B

| | | | | | |
|---|---|---|---|---|---|
| Mixing ratio A:B (by weight) | 17.2 | 17.2 | 17.2 | 17.2 | 17.2 |
| Rise in viscosity during pot life | S | S | S | S | S |
| (continuous (K) or instant (S)) | | | | | |
| Pot life [min] | 94 | 60 | 69 | 30 | 26 |

TABLE 5
Experiments R-4 to R-6 (reference experiments)
and I-8 and I-9 (inventive).

| | | | | | |
|---|---|---|---|---|---|
| Example | R-4 | I-8 | R-5 | I-9 | R-6 |

First component A (amounts in parts by weight)

| | | | | | |
|---|---|---|---|---|---|
| Polymer STP-1 | 33.1 | 33.1 | 33.1 | 33.1 | 33.1 |
| containing silane groups | | | | | |
| Acclaim 4200 | 11.4 | 11.4 | 11.4 | 11.4 | 11.4 |
| Silquest A-171 | 2.5 | 2.5 | — | — | — |
| Silquest A-1110 | 1.2 | 1.2 | 1.2 | 1.2 | — |
| KBE-9103P | — | — | — | — | 3.0 |
| Dynasylan PTMO | — | — | 2.5 | 2.5 | 2.5 |
| Catalyst K1 | — | 0.3 | — | 0.3 | — |
| Catalyst K2 | 0.13 | — | 0.13 | — | 0.13 |
| Socal | 50 | 50 | 50 | 50 | 50 |

Second component B (amounts in parts by weight)

| | | | | | |
|---|---|---|---|---|---|
| Water | 40 | 40 | 40 | 40 | 40 |
| Aerosil 200 | 10 | 10 | 10 | 10 | 10 |
| Acclaim 12200 | 50 | 50 | 50 | 50 | 50 |

Properties of the mixture of the two components A and B

| | | | | | |
|---|---|---|---|---|---|
| Mixing ratio A:B (by | 50 | 50 | 50 | 50 | 50 |
| weight) | | | | | |
| Rise in viscosity during | K | S | K | S | K |
| pot life (continuous (K) | | | | | |
| or instant (S)) | | | | | |
| Pot life [min] | 39 | 147 | 39 | 159 | 109 |
| Tensile strength [MPa] | 4.24 | 3.94 | 3.09 | 4.11 | 3.80 |
| Elongation at break [%] | 341 | 402 | 358 | 529 | 438 |
| Modulus of elasticity | 1.84 | 1.52 | 1.4 | 1.3 | 1.45 |
| [MPa] | | | | | |

TABLE 6
Experiments R-7 and R-8 (reference experiments)
and I-10 to I-12 (inventive).

| | | | | | |
|---|---|---|---|---|---|
| Example | R-7 | R-8 | I-10 | I-11 | I-12 |

First component A (amounts in parts by weight)

| | | | | | |
|---|---|---|---|---|---|
| Polymer STP-1 containing silane | 81.3 | 75.8 | 75.8 | 78.2 | 78.8 |
| groups | | | | | |
| Silquest A-171 | 5.5 | 5.5 | 5.5 | 2.76 | — |
| KBE-9103P | 5.5 | 11.0 | 11.0 | 11.0 | 11.0 |
| Dynasylan PTMO | — | — | — | — | 5.5 |
| Catalyst K1 | — | — | 0.62 | 0.62 | 0.62 |
| Catalyst K2 | 0.31 | 0.31 | — | — | — |
| DINCH | 7.4 | 7.4 | 7.1 | 7.1 | 7.1 |

Second component B (amounts in parts by weight)

| | | | | | |
|---|---|---|---|---|---|
| Water | 40 | 40 | 40 | 40 | 40 |
| Aerosil 200 | 10 | 10 | 10 | 10 | 10 |
| Acclaim 12200 | 50 | 50 | 50 | 50 | 50 |

Properties of the mixture of the two components A and B

| | | | | | |
|---|---|---|---|---|---|
| Mixing ratio A:B (by weight) | 17.2 | 13.3 | 17.2 | 17.2 | 17.2 |
| Rise in viscosity during pot life | K | K | S | S | S |
| (continuous (K) or instant (S)) | | | | | |
| Pot life [min] | 34 | 29 | 86 | 94 | 134 |

1. A two-component composition consisting of a component A comprising
i) at least one organic polymer STP containing silane groups;
ii) optionally at least one desiccant;
iii) optionally at least one amine AM having at least one free amino group or one latent amino group releasable via hydrolysis;
iv) optionally at least one hydrolyzable silane OS having no amino group; and
v) at least one catalyst K for the crosslinking of silane-functional polymers; and a component B comprising
i) between 1% and 75% by weight of water, based on component B;
and optionally, in component A and/or component B, further additives selected from the group consisting of fillers, hydrophilic or hydrophobic silicas, plasticizers, solvents, rheology additives, surfactants, pigments, emulsifiers, UV or oxidation stabilizers, flame retardants, biocides and non-moisture-reactive polymers or resins;
wherein
catalyst K is a tin complex of formula (V) that has two mercaptide ligands, 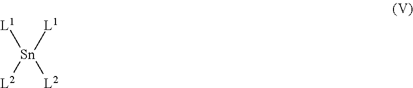
where ligands L¹ are each independently alkyl mercaptides coordinated via sulfur, especially C₆ to C₁₆ alkyl mercaptides, where ligands L¹ optionally have methyldialkoxysilane groups and ligands L² are each independently alkyl ligands.

2. The two-component composition as claimed in claim 1, wherein the amine AM comprises or consists of a silane AS containing amino groups.

3. The two-component composition as claimed in claim 1, wherein the amine AM has at least one primary and/or one secondary amino group.

4. The two-component composition as claimed in claim 1, wherein component A comprises a desiccant in an amount of between 1% by weight and 15% by weight, based on component A.

5. The two-component composition as claimed in claim 1, wherein component A contains between 25% by weight and 85% by weight of organic polymer STP containing silane groups, based on component A.

6. The two-component composition as claimed in claim 1, wherein the hydrolyzable silane OS that does not have an amino group in component A comprises at least one silane of the formula (III) 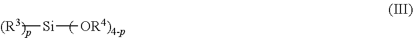
where the radical R³ is each independently a linear or branched, monovalent hydrocarbyl radical that has 1 to 12 carbon atoms and optionally includes one or more heteroatoms, and optionally one or more C—C multiple bonds and/or optionally cycloaliphatic and/or aromatic components;
the R⁴ radical is a hydrogen atom or a methyl or ethyl group; and p has a value of 0 to 3.

7. The two-component composition as claimed in claim 2, wherein the silane AS containing amino groups comprises at least one trialkoxysilane having an aminoalkyl radical which is bonded to the silicon atom and has primary and/or secondary amino groups, and/or comprises at least one organosilane of formula (Ha) 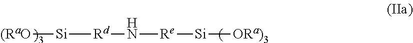
where R^{d} is a divalent linear or branched alkyl radical that has 2 to 10 carbon atoms and optionally contains a hydroxyl group and an ether oxygen; and
R^{e} is a divalent linear or branched alkyl radical that has 2 to 10 carbon atoms and optionally contains a secondary amino group; and
R^{a} is a hydrogen atom or a methyl or ethyl group.

8. The two-component composition as claimed in claim 1, wherein the organic polymer STP containing silane groups is selected from the group consisting of the following polymers containing silane groups: polyethers, poly(meth)acrylates, polyolefins, polyesters, polyamides, polyurethanes and mixed forms of these polymers.

9. The two-component composition as claimed in claim 1, wherein component A, based in each case on the overall component A, contains
between 10% by weight and 50% by weight of organic polymer STP containing silane groups; and
between 25% by weight and 60% by weight of fillers; and
between 0.1% by weight and 15% by weight of amine AM; and
between 0.1% by weight and 15% by weight of desiccant; and
between 0.1% and 15% by weight of hydrolyzable silane OS having no amino group; and
between 5% by weight and 25% by weight of plasticizer; and
between 0.1% and 5% by weight of catalyst K; and
optionally further additives selected from the group defined in claim 1,
with the proviso that the respective amounts are selected such that they all add up to 100% by weight.

10. The two-component composition as claimed in claim 1, wherein component B, based in each case on the overall component B, contains
between 5% by weight and 60% by weight of water; and
between 5% by weight and 20% by silica; and
between 20% by weight and 60% by weight of plasticizer; and
optionally further additives selected from the group defined in claim 1, with the proviso that the respective amounts are selected such that they all add up to 100% by weight.

11. The two-component composition as claimed in claim 1, wherein, in the catalyst K of the formula (V), both ligands L¹ are dodecyl mercaptide and both ligands L² are octyl.

12. The two-component composition as claimed in claim 1, wherein the weight ratio of component A to component B on mixing is >1:1.

13. An adhesive, sealant, coating, or casting compound comprising the two-component composition as claimed in claim 1.

14. The adhesive, sealant, coating, or casting compound as claimed in claim 13, wherein the two-component composition is configured for use in industrial manufacture.

15. A cured compound obtained from a two-component composition as claimed in claim 1 by mixing component A with component B.
